(19) United States
(12) Patent Application Publication
(10) Pub. No.: US 2014/0132619 A1
(43) Pub. Date: May 15, 2014

(54) Simulating Interaction of Different Media

(71) Applicant: MICROSOFT CORPORATION, Redmond, WA (US)

(72) Inventors: Hans Thomas Landsberger, Greenwich, CT (US); Subha Bhattacharyay, Medina, WA (US); Gerard Zytnicki, Seattle, WA (US); Jeffrey A. Herold, Kirland, WA (US); Christopher S. Lester, Redmond, WA (US); Ira L. Snyder, JR., Bellevue, WA (US); John A. Szofran, Seattle, WA (US); Fan Zhang, Redmond, WA (US); Kaushik Barat, Redmond, WA (US)

(73) Assignee: Microsoft Corporation, Redmond, WA (US)

(21) Appl. No.: 13/677,009

(22) Filed: Nov. 14, 2012

(51) Int. Cl. G09G 5/02

(52) U.S. Cl. CPC G09G 5/026
USPC 345/589; 345/581

(57) ABSTRACT

A graphics system is described for simulating the interaction of two or more types of media on a simulated canvas. The graphics system performs this task by consulting a media adhesion matrix which determines a type of behavior that is produced when an attempt is made to add a new medium over the top of an existing medium. In one scenario, the new medium is a watercolor medium which does not apply over a hydrophobic media (such as an oil medium), but may tunnel under such hydrophobic medium in a flow layer during a simulation operation. Various provisions are also disclosed herein to improve the efficiency of the simulation operation.

### BACKGROUND

Developers have proposed various graphics applications which simulate the application of paint to a canvas to produce artwork. There remains an ongoing effort to make these graphics applications more realistic and versatile. A developer will also typically attempt to create painting-related effects in a technically sound manner, to thereby ensure that the effects can be executed on various commercially-available user devices in an efficient and user-friendly manner.

### SUMMARY

A graphics system is described herein for simulating the interaction of differing media. In operation, the graphics system determines, for each affected position: (a) a type of new medium that a user seeks to add to a simulated canvas; (b) a type of existing medium (if any) that has already been applied to the simulated canvas; and (c) a media interaction behavior that governs the application of the new medium, based on at least factors (a) and (b). The graphics system then applies the new medium to the simulated canvas, if possible, based on the media interaction behavior that has been determined.

In one case, the new medium is a watercolor medium and the existing medium is a hydrophobic (water-repellent) medium, such as an oil medium. In that case, according to one non-limiting implementation, the media interaction behavior specifies that the watercolor medium cannot be applied over the top of the hydrophobic medium. However, in one implementation, the graphics system may simulate the tunneling of the watercolor medium beneath the hydrophobic medium within a flow layer of the simulated canvas.

According to another illustrative aspect, the graphics system can utilize a media adhesion matrix to determine the media interaction behavior. That matrix can be extensible in nature. For instance, a developer or end-user can add new media types and/or new media interaction behaviors to the table, and/or can change existing specified media interaction behaviors.

According to another illustrative aspect, the graphics system may employ various provisions to improve the efficiency of its simulation operation.

The above approach can be manifested in various types of systems, components, methods, computer readable storage media, data structures, articles of manufacture, and so on.

This Summary is provided to introduce a selection of concepts in a simplified form; these concepts are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 shows a graphics system that simulates the application of one or more types of media onto a simulated canvas.

FIG. 2 shows a media adhesion matrix that the graphics system of FIG. 1 can use to determine an appropriate media interaction behavior to be applied.

FIGS. 3-5 illustrate three respective behaviors that the graphics system of FIG. 1 may perform in response to a request to add a new medium to an existing medium.

FIG. 6 shows a tunnel-under behavior that the graphics system may perform when a watercolor medium is placed adjacent to a hydrophobic medium, such as an oil medium.

FIGS. 7 and 8 show one particular implementation of the graphics system of FIG. 1. That is, FIG. 7 emphasizes the functional aspects of the implementation, while

FIG. 8 emphasizes the hardware-related aspects.

FIG. 9 illustrates a three-layer model of a simulated canvas.

FIG. 10 illustrates a manner in which a Lattice-Boltzmann Equation (LBE) technique may be applied to simulate movement of particles in a flow layer of the three-layer model.

FIG. 11 illustrates a manner in which a watercolor medium may tunnel under a hydrophobic medium, within the flow layer of the three-layer model of FIG. 9.

FIG. 12 illustrates a yet more specific implementation of the graphics system of FIG. 1. This implementation is particularly configured to simulate the application of a watercolor medium using the three layer model of FIG. 9.

FIG. 13 is a flowchart that represents one illustrative manner of operation of the graphics system of FIG. 1.

FIG. 14 shows illustrative computing functionality that can be used to implement any aspect of the features shown in the foregoing drawings.

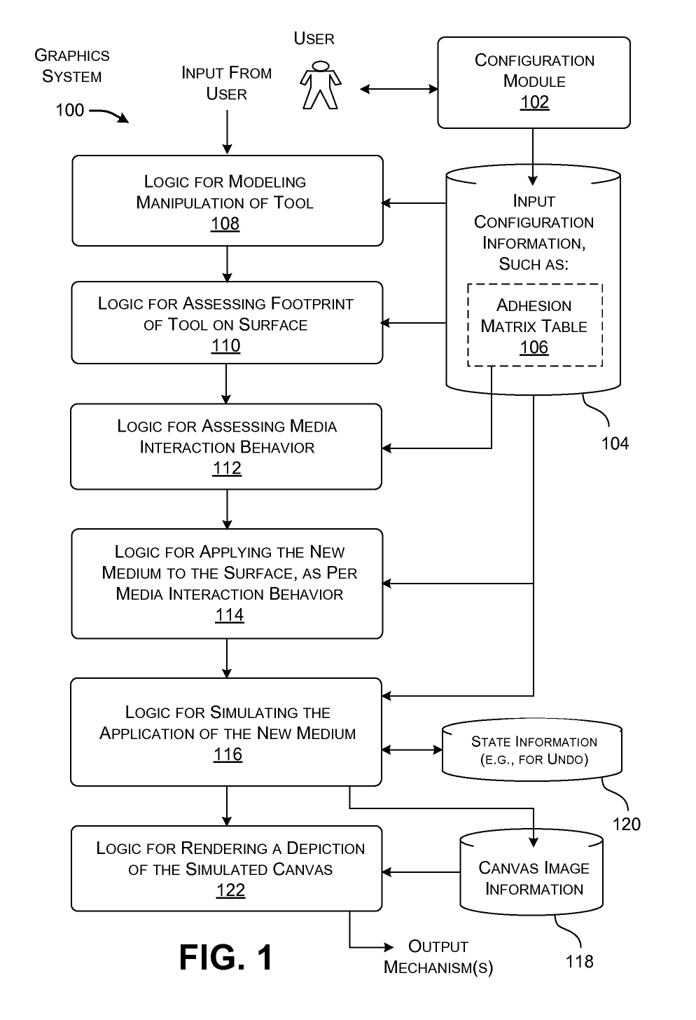

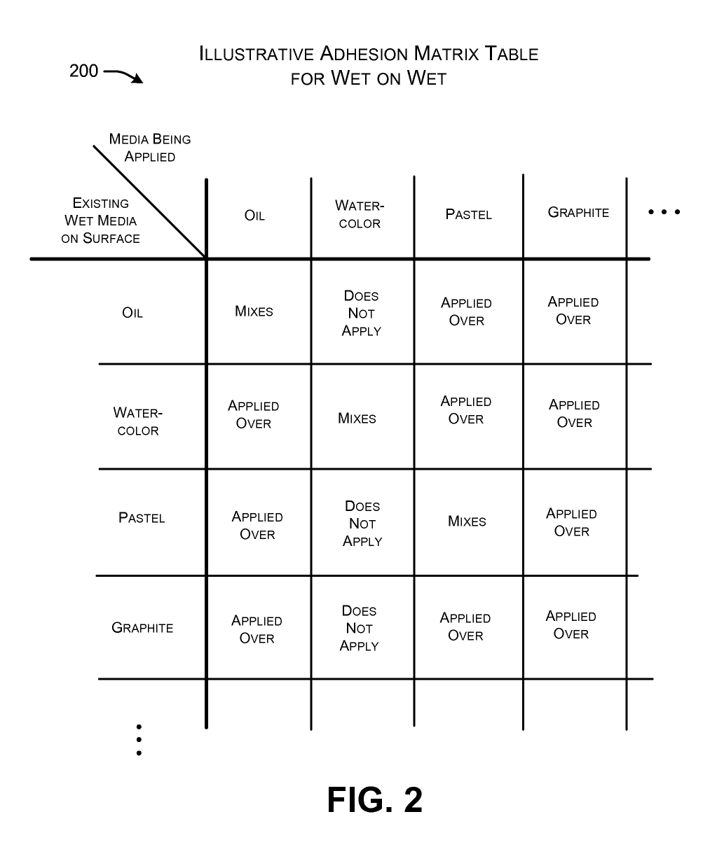

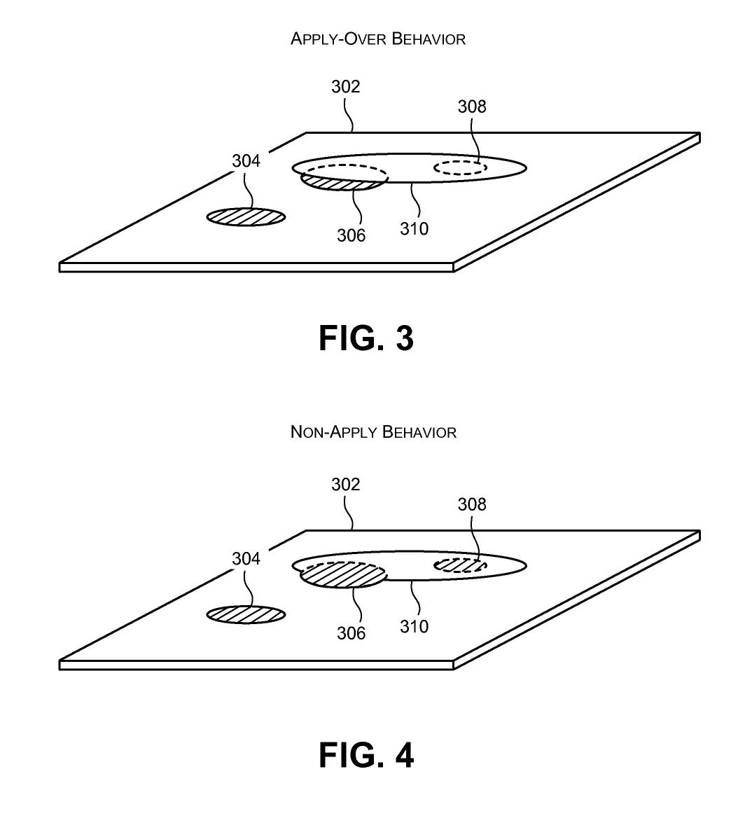

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

This disclosure is organized as follows. Section A describes an illustrative graphics system for simulating the interaction of two or more different kinds of media on a simulated canvas. Section B describes illustrative methods which explain the operation of the graphics system of Section A. Section C describes illustrative computing functionality that can be used to implement any aspect of the features described in Sections A and B. Section D provides illustrative details regarding one way of simulating the flow of a watercolor medium within a three-layer model.

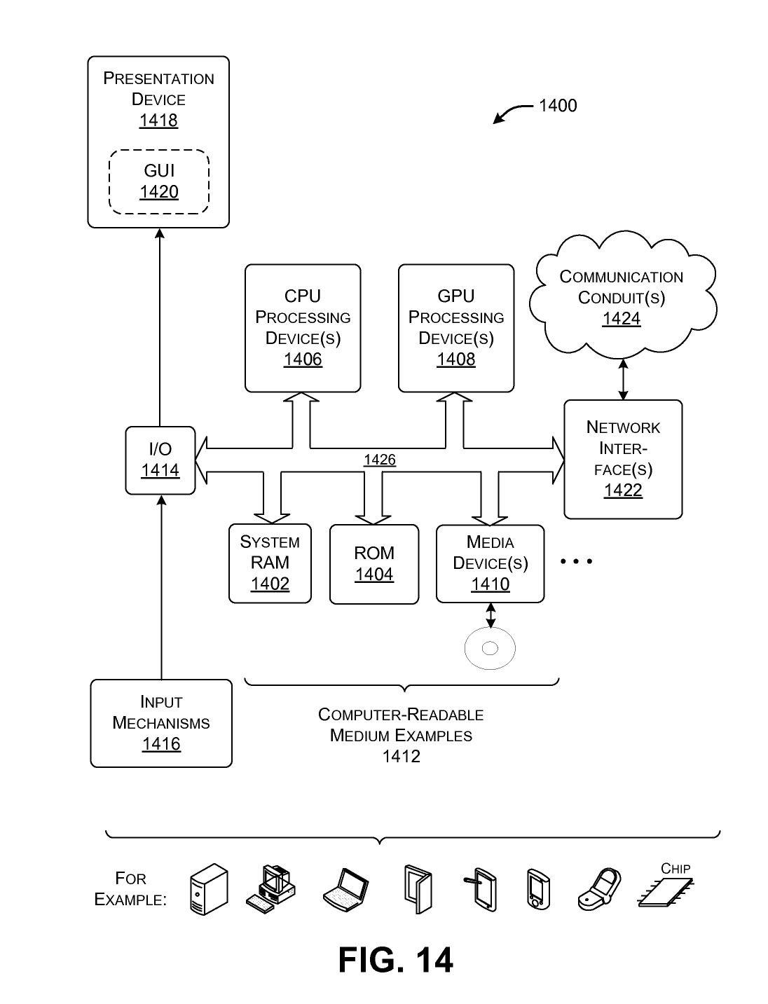

As a preliminary matter, some of the figures describe concepts in the context of one or more structural components, variously referred to as functionality, modules, features, elements, etc. The various components shown in the figures can be implemented in any manner by any physical and tangible mechanisms, for instance, by software, hardware (e.g., chip-implemented logic functionality), firmware, etc., and/or any combination thereof. In one case, the illustrated separation of various components in the figures into distinct units may reflect the use of corresponding distinct physical and tangible components in an actual implementation. Alternatively, or in addition, any single component illustrated in the figures may be implemented by plural actual physical components. Alternatively, or in addition, the depiction of any two or more separate components in the figures may reflect different functions performed by a single actual physical component. FIG. 14, to be described in turn, provides additional details regarding one illustrative physical implementation of the functions shown in the figures.

Other figures describe the concepts in flowchart form. In this form, certain operations are described as constituting distinct blocks performed in a certain order. Such implementations are illustrative and non-limiting. Certain blocks described herein can be grouped together and performed in a single operation, certain blocks can be broken apart into plural component blocks, and certain blocks can be performed in an order that differs from that which is illustrated herein (including a parallel manner of performing the blocks). The blocks shown in the flowcharts can be implemented in any manner by any physical and tangible mechanisms, for instance, by software, hardware (e.g., chip-implemented logic functionality), firmware, etc., and/or any combination thereof.

As to terminology, the phrase “configured to” encompasses any way that any kind of physical and tangible functionality can be constructed to perform an identified operation. The functionality can be configured to perform an operation using, for instance, software, hardware (e.g., chip-implemented logic functionality), firmware, etc., and/or any combination thereof.

The term “logic” encompasses any physical and tangible functionality for performing a task. For instance, each operation illustrated in the flowcharts corresponds to a logic component for performing that operation. An operation can be performed using, for instance, software, hardware (e.g., chip-implemented logic functionality), firmware, etc., and/or any combination thereof. When implemented by a computing system, a logic component represents an electrical component that is a physical part of the computing system, however implemented.

The phrase “means for” in the claims, if used, is intended to invoke the provisions of 35 U.S.C. §112, sixth paragraph. No other language, other than this specific phrase, is intended to invoke the provisions of that portion of the statute.

The following explanation may identify one or more features as “optional.” This type of statement is not to be interpreted as an exhaustive indication of features that may be considered optional; that is, other features can be considered as optional, although not expressly identified in the text. Finally, the terms “exemplary” or “illustrative” refer to one implementation among potentially many implementations

A. Illustrative Graphics System

FIG. 1 shows a graphics system 100 which simulates the process of creating artwork. In this process, a user applies one or more types of media onto a simulated canvas, to create a simulated painting, drawing, etc., or some combination thereof. The graphics system 100 is generally designed such that the artwork that is produced resembles, as closely possible, an actual art product. However, the graphics system 100 may also produce effects that diverge from the manner in which physical types of media interact with physical substrates.

Without limitation, the types of media that may be applied to the simulated canvas include a watercolor medium, an oil medium, a graphite medium, a pastel medium, a crayon-type medium, and so on. However, to facilitate explanation, each of these media types will be loosely referred to below as a form of simulated paint. For example, even crayon is referred to as a type of paint in the interest of simplifying the terminology used herein.

FIG. 1 will be described below in a generally top-to-bottom manner. To begin with, a developer, end-user, or other individual may interact with a configuration module 102 to input configuration information into a data store 104. The configuration information governs various aspects of the simulation process executed by the graphics system 100. For example, the configuration information may specify the equations used by the graphics system 100, and the values of parameters used in those equations. Further, the configuration information may specify the surface texture of the simulated canvas, the fibrous structure of the simulated canvas, the deposition of additives (such as alum) on the simulated canvas, and so on.

The graphics system 100 may also store a media adhesion matrix table 106 in the data store 104. The adhesion matrix table 106 specifies the media interaction behavior that is produced when applying a stroke of new paint over a stroke of existing paint. That is, the stroke of existing paint corresponds to paint of any type that the user has previously applied to the simulated canvas. The stroke of new paint corresponds to paint of any type that the user wishes to apply, at least in part, over the stroke of existing paint. To repeat, the word “paint” encompasses any type of media.

FIG. 2 illustrates one such media adhesion matrix table 200. This table 200 specifically describes the behavior that is produced when applying wet new paint over wet existing paint. As will be explained in greater detail below, the configuration module 102 can store multiple such tables (not shown) for different input scenarios.

The adhesion matrix table 200 specifies, without limitation, four different types of new paint (oil, watercolor, pastel, and graphite) and four illustrative types of existing paint (oil, watercolor, pastel, and graphite). The adhesion matrix table 200 also specifies three different types of behavior (“apply over,” “non-apply,” and “mixing”). However, each adhesion matrix table is fully extensible in nature. This means that a user can add new kinds of paint to a table, and/or change any behavior specified in the table.

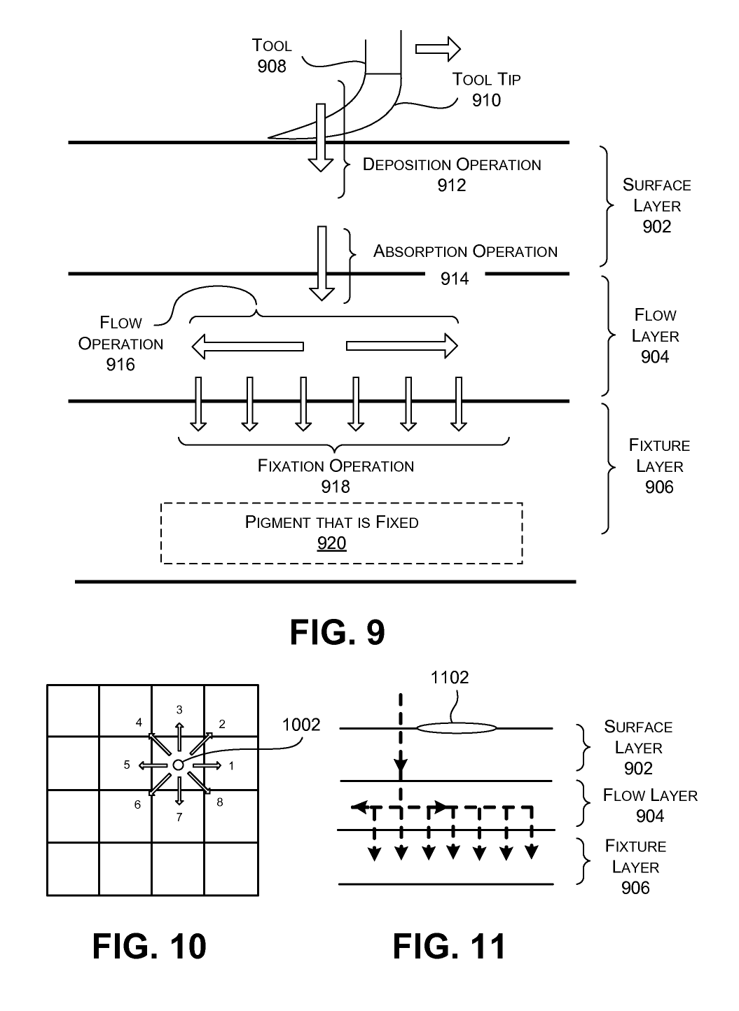

FIGS. 3-5 illustrate three different types of behavior specified in the adhesion matrix table of FIG. 2. Note that these figures depict a simulated canvas 302 in a high-level conceptual form. Later figures, such as FIG. 9, will describe a more detailed model of the simulated canvas 302.

Starting with FIG. 3, assume that a user has applied three existing paint strokes (304, 306, and 308) to a surface of the simulated canvas 302. The existing paint strokes (304, 306, 308) are applied using a first type of paint. Then assume that the user seeks to add a new paint stroke 310 to the surface of the simulated canvas 302. The new paint stroke 3010 is applied using a second type of paint. The new paint type may be the same as or different than the existing paint type. For the “applied-over” behavior, the new paint adheres to the existing paint. Thus, the graphics system 100 applies the new paint stroke 310 over the top of any existing paint stroke that lies beneath the new paint stroke 310. In the merely illustrative case of FIG. 3, the new paint stroke 310 completely encompasses the existing paint stroke 308, and partially encompasses the existing paint stroke 306.

According to one manner of behavior, the new paint stroke 310 will have the end result of completely masking the appearance of any existing paint that lies underneath the new paint stroke 310. According to another manner of behavior, the new paint stroke 310 is translucent. The new paint stroke 310 may therefore modify the appearance of the existing paint. For example, the new paint stroke 310 may produce a sheen or glaze over the existing paint. Still other “apply-over” behaviors are possible.

FIG. 4 shows a non-apply behavior. Assume that the same temporal scenario described above applies to FIG. 4; namely, the user applies the existing paint strokes (304, 306, 308) to the simulated canvas 302, followed by the new paint stroke 310. In this case, the graphics system 100 prevents the new paint stroke 310 from being applied to any portion of the simulated canvas 302 that has the existing paint disposed beneath it. As a result, the existing paint strokes (304, 306, 308) will not be affected by the application of the new paint stroke 310. This further means that the existing paint will remain fully visible following the application of the new paint stroke 310.

The graphics system 100 can achieve the non-apply behavior in different ways. In one case, the graphics system 100 can prevent application of the new paint to the existing paint, without simulating the flow of the new paint over the existing paint. In another case, the graphics system 100 can simulate a physical phenomenon in which a quantity of new paint that is deposited on an existing paint stroke will be shed from the surface of the existing paint stroke. The shedding process may deposit the new paint at the perimeter of the existing paint stroke. The shedding process itself can be simulated in any level of detail. For example, suppose that the existing paint exhibits simulated three-dimensional ridges produced by the bristles of the brush. The graphics system 100 can simulate the flow of new paint along channels created by the ridges in the existing paint. This flow will depend on the simulated orientation of the canvas with respect to the direction gravity, among other factors.

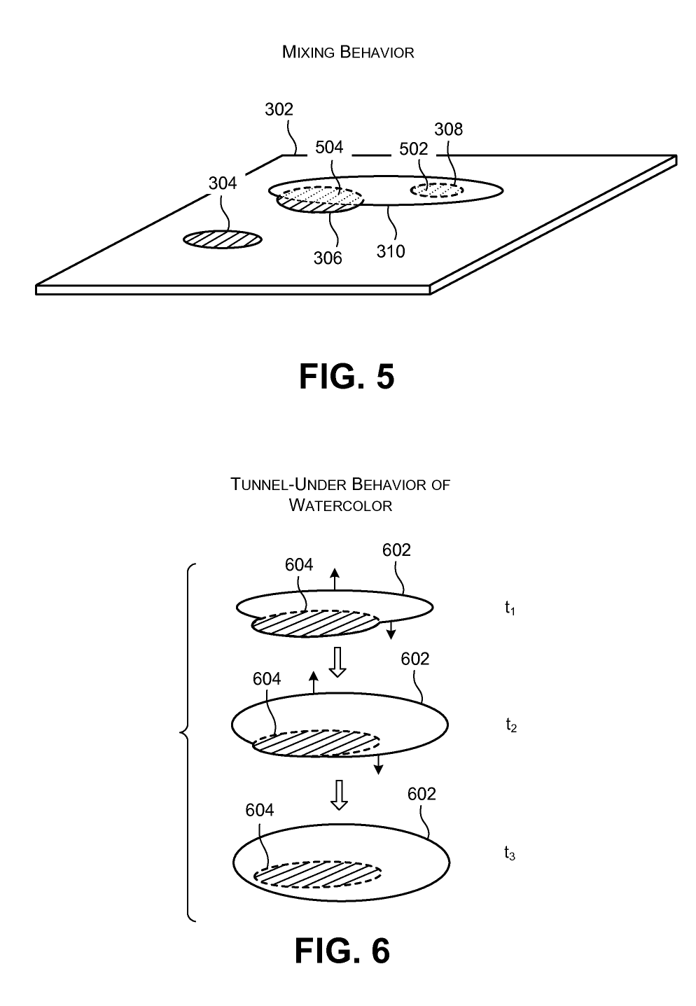

FIG. 5 shows a mixing behavior. Assume that the same temporal scenario described above applies to FIG. 5; namely, the user applies the existing paint strokes (304, 306, 308) to the simulated canvas 302, followed by the new paint stroke 310. In this case, the graphics system 100 will mix the new paint with the existing paint in any region in which the new paint is applied over the existing paint. In FIG. 5, those mixing regions include region 502, which corresponds to the entire area of the existing paint stroke 308, and region 504, which corresponds to a portion of the existing paint stroke 306.

The graphics system 100 can produce the mixing behavior in different ways. In one case, the graphics system 100 can produce a new color for application to the mixing regions (502, 504) that is a combination of the pigment of the existing paint and the pigment in the new paint. In addition, the graphics system 100 can combine other simulated physical properties of the existing paint and new paint, such as the viscosities of the paints, etc.

Returning to FIG. 2, the illustrative adhesion matrix table 200 specifies that new oil paint will mix with existing oil paint, but new oil paint will be applied over all other forms of paint (watercolor, pastel, graphite, etc.). The pastel medium has the same behavior as the oil paint. The table 200 further specifies that new watercolor paint may mix with existing wet watercolor paint, but new watercolor paint will not be applied over any other form of paint. In other words, the other forms of paint can be considered as hydrophobic in that they repel water, or at least partially repel water. Finally, a new graphite medium is applied over all forms of other media. To emphasize once again, the paint types and associated behaviors illustrated in FIG. 2 can be modified and/or supplemented in any way.

Another table (not shown) can specify the effect of adding a stroke of new paint to existing paint when the existing paint is dry (instead of wet, which is the assumption of FIG. 2). For example, this table may specify that new watercolor paint can be applied over dry watercolor paint, but that the new watercolor paint will not adhere to any other forms of paint (as in the case of FIG. 2). But this behavior can be changed to specify that new watercolor paint can also be applied over other forms of dry existing paint. For example, new watercolor paint can add a translucent sheen or glaze when applied over existing oil paint.

Other tables (not shown) can be applied for different kinds of tools that are used to apply the paint. For example, FIG. 2 corresponds to the case in which the new paint is applied using a simulated brush or other tool that deposits new paint on the simulated canvas (such as a pencil, etc.). Another tool allows a user to blend new paint into existing paint, where both the new paint and existing paint are already deposited on the canvas. A tool-specific media adhesion table can be consulted which determines the behavior produced by this tool for different combinations of media types.

Still other tables are possible for different input scenarios. Factors that may affect the media interaction behavior include, but are not limited to: the type of paint being applied to the simulated canvas; the type of paint that already exists on the simulated canvas; the state of the paint(s) (e.g., whether the paints are wet or dry, etc.); the orientation of the simulated canvas with respect to the direction of gravity; the simulated temperature, humidity, etc. under which the paint(s) are applied; the tool(s) used to apply the paint(s); the curing process(es) (if any) which are applied to the paint(s); the additives (if any) which are added to the paint(s), and so on. Also, the type(s) of paint can take into account different possible chemical and/or mechanical properties of the paints. Generally, one or more adhesion matrix tables may specify behaviors for any combinations of the factors described above, treating the factors as input information to a behavior look-up process.

In another case, a table can define the media interaction behavior when a new paint stroke is added to an area of the simulated canvas having two or more existing layers of paint. In yet another case, any behavior specified in any table can be a composite of two or more component behaviors described above. For example, a behavior may specify that new paint will partially shed away from existing paint, but may also partially adhere to the existing paint.

Returning to FIG. 1, the remainder of the illustrative functionality employed by the graphics system 100 will now be described. A logic component 108 moves a simulated tool with respect to the canvas in response to input from the user. Illustrative types of simulated tools include brushes of different types, pencils, crayons, smudge tools, erasers, palette knives, airbrushes, and so on. More specifically, as a default, the logic component 108 may position the simulated tool so that it hoovers above the simulated canvas. The user may then control the tool to change any aspect of its position and orientation with respect to the simulated canvas. For instance, the user can apply new paint to the surface of the canvas by moving the tool such that it contacts the canvas, and then optionally moving the tool along the surface of the canvas. Alternatively, the user can apply paint to the canvas without bringing the tool into contact with the canvas, such as by flicking a brush towards the canvas, or by using an airbrush, etc. A logic component 110 assesses the footprint that the tool makes when it contacts the surface of the canvas, or the footprint that paint droplets produce when they strike the canvas, etc.

Known techniques can be used to implement the logic components 108 and 110. For example, without limitation, the graphics system 100 can employ the tool modeling functionality described in common-assigned U.S. patent application Ser. No. 12/756,190, filed Aug. 8, 2010, entitled “Simulating Painting,” and naming the inventors of Baxter, III et al. In addition, or alternatively, the graphics system 100 can use the technology described in Chu, et al., “Real Time Painting with an Expressive Virtual Chinese Brush,” IEEE Computer Graphics and Applications, 2004, pp. 76-85.

A logic component 112 assesses the media interaction behavior that will govern the application of new paint to the digital canvas. The logic component 112 executes this task by performing a test for each position of the simulated canvas that is affected by the new paint stroke. For example, the logic component 112 can perform a test for each position encompassed by the footprint determined by the logic component 110. Here, the term “affected position” has broad connotation. In one case, the simulated canvas includes an array of elements. A position may correspond to a particular element in the array, or, more precisely, a representative position of that element in the array. The elements may correspond to pixels, or may have sizes larger than pixels, or sizes smaller than pixels.

In one case, the test may comprise, for each affected position: (a) determining the type of new paint to be applied at that position; (b) determining the type of existing paint that is already applied at that position (if any); and (c) determining the interaction rule that governs the application of the new paint to the existing paint. As explained above, the logic component 112 can take into consideration any number of additional factors in making an adhesion-related assessment.

A logic component 114 applies, at each affected position, the new paint to the surface of the simulated canvas, as per the interaction behavior determined by the logic component 112. In some cases, this operation involves adding the new paint over the top of the existing paint. In other cases, this operation involves prohibiting the addition of the new paint over the top of the existing paint. In other cases, this operation involves mixing the new paint with the existing paint. As explained above, these behaviors can be implemented in different ways to mimic different physical interaction phenomena. And as said, the graphics system 100 can accommodate additional behaviors.

A logic component 116 simulates the effects that are produced by adding the new paint to the existing paint. In some cases, the effects manifest themselves in gradual fashion over a period of time following the application of the new paint to the simulated canvas. For example, consider the scenario in which the user adds a watercolor paint to the surface of the simulated canvas. As will be explained in detail below, the watercolor paint will seep into a flow layer of the canvas. The watercolor paint will then laterally disperse in the flow layer through its simulated fibers. As the watercolor paint dries, the pigments in the paint will move to a fixture layer of the canvas. The logic component 116 simulates this dynamic behavior.

Consider, for example, the particular scenario shown in FIG. 6. Here, at an initial time t₁, the user adds a new watercolor stroke 602 to the surface layer of the simulated canvas. That new watercolor stroke 602 at least partially overlaps an existing oil paint stroke 604. The graphics system 100 adds the new watercolor stroke 602 to the simulated canvas such that none of the watercolor paint adheres to or penetrates the oil paint stroke 604. As such, the existing oil paint stroke 604 has the effect of disrupting the path of the watercolor stroke 602.

However, the watercolor paint seeps into the flow layer and continues to disperse in all directions. In one implementation, the logic component 116 also simulates the tunneling of the watercolor paint beneath the existing oil paint stroke 604. For example, at time t₂ the watercolor paint has dispersed to define a first perimeter, and at time t₃ the watercolor paint has dispersed to define a second perimeter, larger than the first perimeter. Note that, at time t₃, part of the watercolor paint has completely tunneled under the existing oil paint stroke 604 in the flow layer, and has emerged on the “other side” of the oil paint stroke 604. Hence, pigments that have been deposited in the fixture layer will be visible on the other side of the oil paint stroke 604.

The logic component 116 can produce yet other simulation effects. For example, assume that a new oil paint stroke is added to an existing oil paint stroke, and that the existing oil paint stroke is still wet. The logic component 116 can simulate the mixing of pigments in the new and existing paints. (In some cases, the wet paint from the simulated canvas may also move to the brush of the tool, where it mixes with the paint on the brush.)

As a result of its simulation, the logic component 116 can produce an updated image of the simulated canvas in a data store 118. This image is referred to herein as canvas image information. The canvas image information captures the appearance of the simulated canvas at a particular point in time.

The logic component 116 can also store state information in a data store 120 that represents, at a particular time, the state of the simulation produced by the logic component 116. For example, assume that, at the particular time, the watercolor paint is still flowing within the flow layer of the simulated canvas. The logic component 116 can store state information pertaining to this intermediate non-stable state.

Finally, a logic component 122 renders a depiction of the simulated canvas based on the canvas image information. The logic component 122 can then present that depiction to the user using any output mechanism, such as a display device, a printer, and so on. The rendering operation performed by the logic component 122 can take into account such factors as scaling effects, zoom level, panning effects, shadow effects, and so on. The logic component 122 can, in addition, or alternatively, send the canvas image information to a storage device for archiving.

The user can also remove paint that was previously added to the canvas. In one approach, the user accomplishes this objective using an eraser tool. In one implementation, the graphics system 100 performs an erasure operation by removing all layers of media that lie beneath the path of the eraser tool as it traverses the simulated canvas. For example, if a particular part of the simulated canvas includes oil paint applied on top of watercolor paint, the graphics system 100 will remove all paint from the designated part.

The logic component 116 can respond to an erasure command in various scenario-specific ways. Consider, for example, the scenario in which a user removes paint from an area of the canvas that is next to wet watercolor paint. In this case, the logic component 116 can simulate the dispersion of watercolor paint back into the region that has been erased. The user can prevent this effect by: (a) waiting until the watercolor paint has dried before executing an erasure operation; or (b) accelerating the drying process in an artificial manner, e.g., by activating a “dry” command or the like.

In another implementation, the graphics system 100 can provide media-specific eraser tools. For example, the user can employ an oil eraser tool which will have the effect of removing oil paint, but not graphite media, and so on. The user can employ a watercolor eraser tool that will remove watercolor paint, but not oil paint, and so on.

In addition, or alternatively, a user can instruct the graphics system 100 to “undo” one or more previous brush strokes. In one implementation, the graphics system 100 supports the undo functionality by storing the state of the simulated canvas prior to the application of each brush stroke. In some scenarios, all media applied to the simulated canvas has reached a stable state at the time that a user applies a new brush stroke. In other scenarios, some paint remains in transition at the time that the user applies the new stroke. For example, watercolor paint may be dispersing within the flow layer at the time that a user seeks to apply a new paint stroke to the canvas. The graphics system 100 is expected to store more state information for the latter case compared to the former. This is because, in the latter case, it may be appropriate for the graphics system 100 to store state information pertaining to the movement of watercolor paint in plural layers of the simulated canvas.

More generally, FIG. 1 shows that the logic component 116, and/or any other component of the graphics system 100, can store state information in a data store 120, in response to any kind of triggering event. When a user activates an undo command, the graphics system 100 retrieves an appropriate state snapshot from the data store 120 to restore the simulated canvas to the appropriate prior state.

In other cases, the graphics system 100 stores a time-stamped record of each stroke (and other actions) that a user makes to create an artwork. If the user wishes to return to a particular point in time, the graphics system 100 can then erase the entire simulated canvas and re-apply all of the brush strokes to the canvas up to the designated point in time.

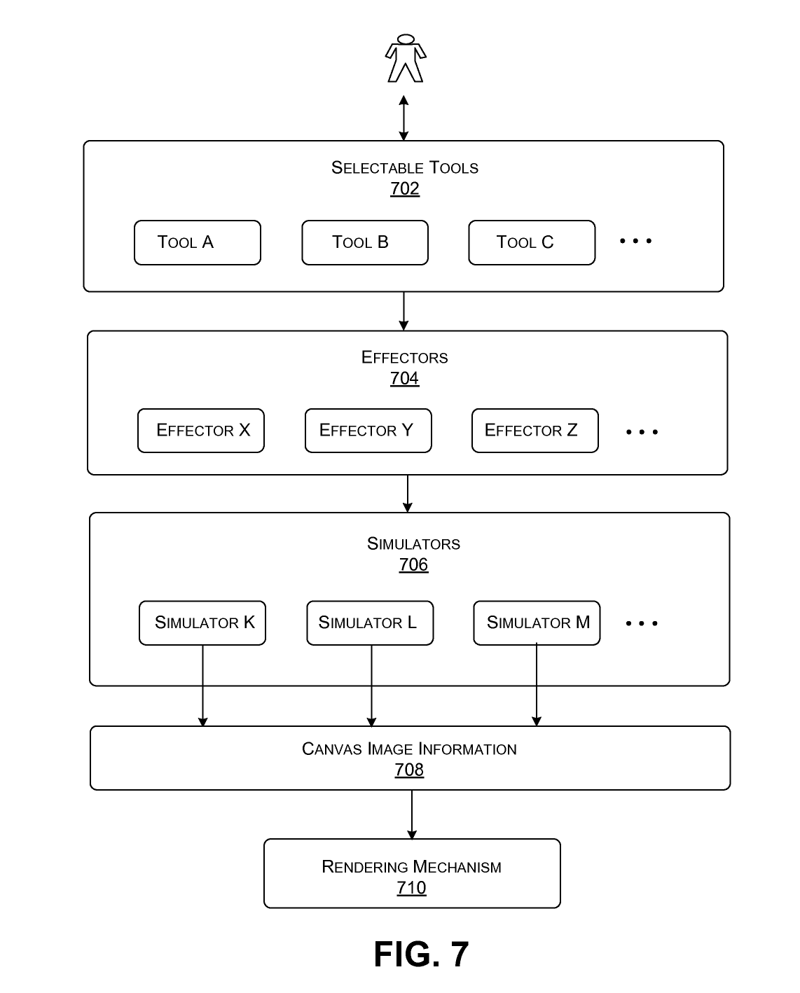

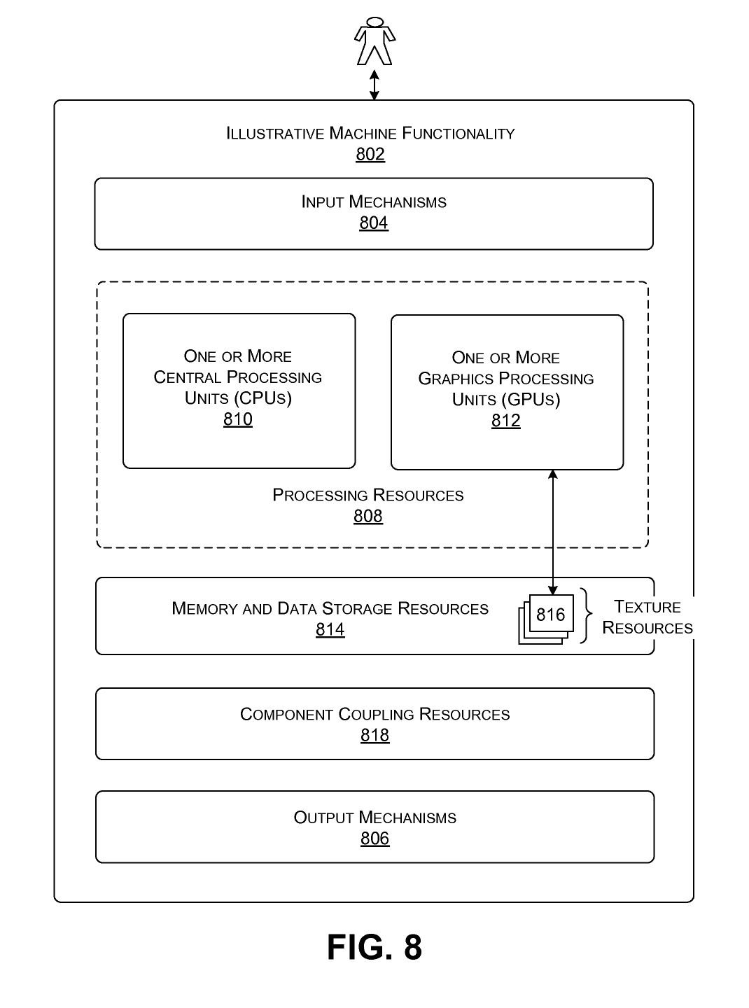

The graphics system 100 described with reference to FIG. 1 can be implemented in different ways. FIGS. 7 and 8 illustrate one such implementation of the graphics system. More specifically, FIG. 7 emphasizes function-related features that can be used to implement the graphics system 100. For example, the modules shown in FIG. 7 can be implemented by software. FIG. 8 emphasizes hardware-related features that can be used to implement the graphics system 100.

Starting with FIG. 7, the graphics system 100 includes a plurality of selectable tools 702, a plurality of effectors 704, and a plurality of simulators 706. The tools 702 correspond to different mechanisms by which a user can add paint to the surface of the simulated canvas, or remove paint from the simulated canvas, or perform some other operation (such as blending) with respect to paint that is already applied to the simulated canvas. As stated above, the tools can include, but are not limited to, brushes, pencils, crayons, smudge tools, erasers, palette knives, air brushes, and so on. Known techniques can be used to model the behavior of these tools. For example, known techniques can be used to simulate the deflection of brush bristles as the user contacts the surface of the simulated canvas with a brush tool.

The effectors 704 simulate the manner in which each of the tools may interact with the surface of the simulated canvas to deposit paint on the canvas. A single tool can invoke different effectors depending on how it is used. For example, consider a brush tool. A user can manipulate the brush tool such that it drags across the surface of the simulated canvas. This action invokes a first effector which models, at each instance of time, the footprint of the brush as it moves across the canvas. A user can alternatively flick the same brush towards the canvas, without touching the canvas. This action invokes second effectors, each of which models a drop of paint produced by the flicking motion.

The graphics system 100 can invoke one of the simulators 706 to simulate the effect that paint has when applied to the canvas. Each simulator may implement the logic component 116 of FIG. 1 for a different kind of paint. For example, the graphics system 100 may invoke a watercolor simulator to simulate the dynamic dispersion of watercolor paint in the canvas. The graphics system 100 may invoke an oil simulator to simulate the mixing process produced when a first oil paint is added to the top of another wet oil paint, and so on. Each simulator may store the results of its operation in updated canvas image information 708.

A rendering mechanism 710, which implements the logic component 122 of FIG. 1, provides a visual depiction of the simulated canvas based on the canvas image information 708.

FIG. 8 shows illustrative machine functionality 802 that can be used to implement the graphics system 100 of FIG. 1, based on the software-related features set forth above (with reference to FIG. 7), or based on any other software features.

In one case, the machine functionality 802 can be implemented by any kind of standalone user device. Without limitation, illustrative types of user devices include: a personal computer, a laptop or netbook-type computer, a tablet-type computer, a mobile telephone device (e.g., a smartphone device), a game console device, a portable game-playing device, a portable music-playing device, a book reader device, a device having a tabletop or wall interaction/display surface, and so on.

In another case, at least some aspects of the machine functionality 802 can be implemented by remote computer functionality. The remote computer functionality can be provided at a single site, or may be distributed over plural sites. For example at least some aspects of the machine functionality 802 can be implemented by remote server computer equipment, data stores, and so on. For instance, the remote equipment may correspond to cloud computing resources or the like. A user can access this equipment using a user device, via any type of network, such as a wide area network (e.g., the Internet), a local area network, point-to-point links, and so on.

However implemented, the machine functionality 802 can include one or more input mechanisms 804. The input mechanisms 804 can include, but are not limited to, any of: touchscreen input mechanisms, stylus-type input mechanisms, gesture input mechanisms (including the Kinect® device provided by Microsoft Corporation of Redmond, Wash., or other motion-sensing device), key input mechanisms, mouse device input mechanisms, voice input mechanisms, tabletop or wall-mounted input mechanisms, and so on. The machine functionality 802 can also include one or more output mechanisms 806. The output mechanisms 806 can include, but are not limited to, any of: display devices, printer devices, three-dimensional modeling devices (for creating three-dimensional models of artwork), storage devices, and so on. In some cases, the machine functionality 802 can perform interpolation on the canvas image information to increase its resolution for output to certain devices, such as a high-resolution printer.

The machine functionality 802 can also include any type or combination of types of processing resources 808. For example, the machine functionality 802 can employ a combination of one or more central processing units (CPUs) 810 and one or more graphical processing units (GPUs) 812. The machine functionality 802 can devote certain processing tasks to the CPUs 810 and other more computation-intensive tasks to the GPUs 812. For example, the machine functionality 802 can use the CPUs 810 to execute at least parts of the logic component 108 of FIG. 1. That logic component 108 receives input from the user and manipulates a simulated tool in response to the input. The machine functionality 802 can use the GPUs 812 to execute at least parts of the logic component 116. That logic component 116 simulates the effects of adding new paint to the canvas, which may represent the most computation-intensive part of the processing performed by the graphics system 100. In general, however, a developer can allocate any functions to any kinds of processing units to suit different environment-specific objectives, in view of existing hardware strengths and limitations of a particular platform.

The machine functionality 802 includes various memory and data storage resources 814. The CPUs 810 and GPUs 812 can interact with these resources 814 in any manner. In one implementation, for example, the GPUs 812 interact with a set of textures 816. One or more of the textures store constant information used by the simulation operation, such as information defining the grain patterns of the simulated canvas, and so on. In some cases, the machine functionality 802 can store a small tile of such constant information, and the graphics system 100 can duplicate this tile over the entire simulation space. One or more other textures store state information associated with the simulation operation. The following description will clarify the nature of the state information that is stored by the simulation operation (for the case in which watercolor paint is applied to the simulated canvas).

In one mode of operation, the GPUs 812 can perform their functions by leveraging a ping-pong type of buffer. That is, the GPUs 812 can read input information from a first buffer memory. After performing computations using that input information, the GPUs can send processed information to a second buffer memory. The second buffer memory may then provide input information to a next round of computations.

The machine functionality 802 also includes component coupling resources 818. These component coupling resources 818 can include bus infrastructure of any type. For example, the component coupling resources 818 can include communication mechanisms for transferring information between the CPUs 810 and the GPUs 812.

The remainder of this section describes techniques by which the graphics system 100 can simulate the movement of watercolor through a canvas. To begin with, FIG. 9 shows a high-level representation of a three-level model of the simulated canvas. The model includes a surface layer 902, a flow layer 904, and a fixture layer 906. A tool 908 deposits watercolor paint onto the surface layer 902, e.g., using a brush-type tool tip 910, or some other mode of application. The watercolor paint itself can be modeled as having at least three basic constituents: water, pigment, and glue. The pigment produces the color of the watercolor paint. The pigment moves with the water, as well as within the water. The glue influences the viscosity of the watercolor paint. The glue can also move with the water, and well as within the water.

FIG. 9 also depicts the movement of watercolor paint within the simulated canvas. In a deposition operation 912, the tool 908 deposits watercolor paint on the surface layer 902. In an absorption operation 914, the watercolor paint seeps from the surface layer 902 to the flow layer 904 at a rate determined, in part, by the wetness level of the underlying flow layer 904. In a flow operation 916, the watercolor paint laterally disperses in the flow layer 904. In a fixation operation 918, the water in the flow layer 904 evaporates at a prescribed rate, causing pigments in the watercolor paint to move into the fixture layer 906.

The graphics system 100 represents the appearance of the watercolor paint during the drying process by combining the pigments in the surface layer 902, the flow layer 904, and the fixture layer 906. But when the watercolor paint has fully dried, the fixture layer 906 holds all of the pigments 920 deposited by the watercolor paint. In one implementation, the graphics system 100 can represent the pigment colors in each layer in cyan/magenta/yellow (CMY) color space, which is a subtractive color space. The graphics system 100 can also combine the colors from different layers in the CMY color space.

However, the graphics system 100 can represent the color of each image element in the final canvas image information in an additive color space, such as the red/green/blue (RGB) color space. More specifically, the graphics system 100 can represent the color using color information (e.g., that defines the RGB color) together with concentration information (e.g., that describes the concentration of the RGB color). The graphics system 100 can adopt this manner of expressing color to accommodate the depiction of light-colored paints on dark backgrounds, in addition to the more common use of paints of varying colors on light-colored backgrounds.

FIG. 10 describes the use of the Lattice Boltzmann Equation (LBE) to simulate the movement of fluid in the flow layer 904. The LBE technique entails partitioning a simulation space into a lattice of discrete elements. The LBE technique then repetitively applies a two-stage analysis to the elements in the lattice. In a first streaming stage, for each element, the LBE technique simulates movements of particles to neighboring elements. In a second collision stage, for each element, the LBE technique simulates the collision of particles that arrive at that same element.

More specifically, a position x 1002 identifies an element within a lattice in a D2Q9 lattice model. In the streaming phase, the LBE technique simulates the movement of particles in nine discrete directions with respect to x, defined by vectors (e₀, e₁, e₂, e₈). FIG. 10 labels these directions with arrows. The vector e₀ corresponds to no movement of particles. The LBE technique simulates the movements of particles in each direction using a distribution function fᵢ(x,t), where t represent time, and i corresponds to one of the nine directions. In the collision phase, the LBE technique computes the manner in which the distribution functions are redistributed towards their respective equilibrium functions fᵢ^{(eq)}.

Different known techniques can be used to implement the LBE equation. In one approach, the graphics system 100 can apply the mathematical equations set forth in Section D below. Those equations, in turn, are based on the modeling described in Chu, et al., “MoXi: Real-time Ink Dispersion in Absorbent Paper,” ACM Transactions on Graphics, Vol. 24, Issue 3, July 2005, pp. 504-511.

FIG. 11 illustrates the same behavior that was earlier set forth with respect to FIG. 4. Here, a user applies a hydrophobic paint stroke 1102 to the surface layer 902 of the simulated canvas. The user then applies watercolor paint adjacent to the hydrophobic paint stroke 1102. The dashed-line arrows indicate the possible path that the watercolor paint may take as it moves through the simulated canvas. As indicated, the watercolor paint may seep from the surface layer 902 to the flow layer 904. In the flow layer 904, the watercolor paint may flow in a lateral direction. In so doing, the watercolor paint can potentially tunnel completely under the hydrophobic paint stroke 1102. As the watercolor paint dries it deposits its pigment in the fixture layer 906. Hence, there is a possibility that the color from the watercolor paint will be visible on both sides of the hydrophobic paint stroke 1102.

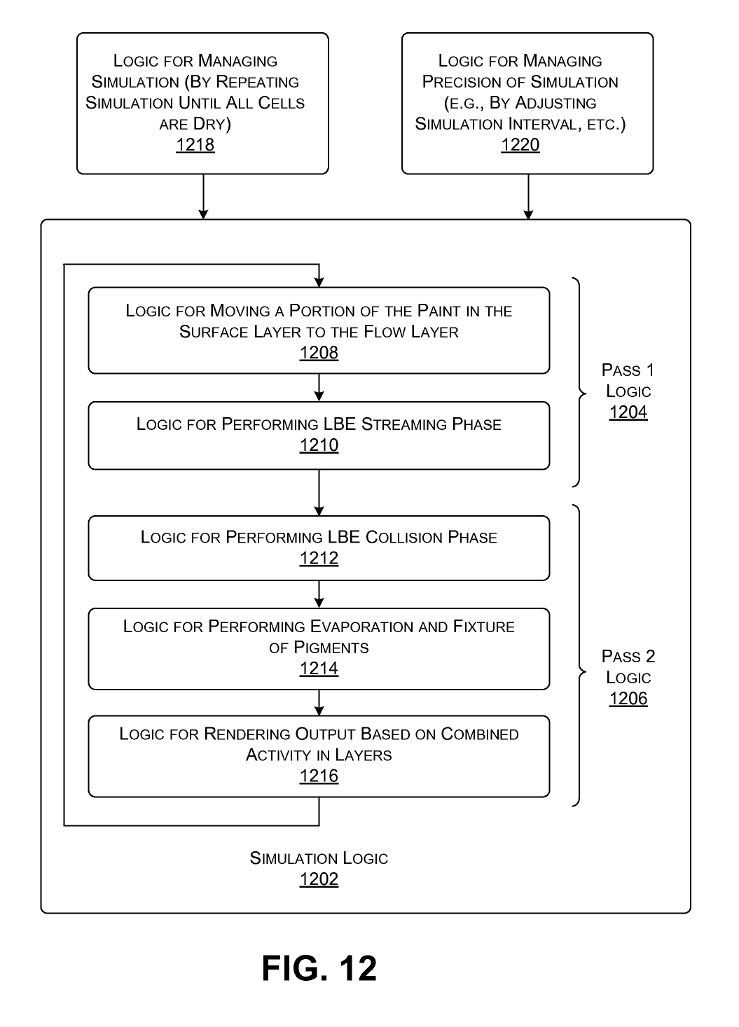

FIG. 12 shows simulation logic 1202 that simulates the flow of watercolor paint using the three-layer model set forth above. In other words, the simulation logic 1202 is an instantiation of at least some functions of the logic component 116 of FIG. 1. The simulation logic 1202 performs its operations by repeatedly executing a two-pass procedure. Pass 1 logic 1204 implements the first pass, while pass 2 logic 1206 implements the second pass.

In the first pass, a logic component 1208 simulates the flow of watercolor from the surface layer 902 into the flow layer 904 (pertaining to the absorption operation 914). A logic component 1210 then executes the first phase of the LBE technique (corresponding to the flow operation 916). That is, this process simulates the streaming aspects of the LBE technique. The logic component 1210 can store the results of its processing as a texture. That texture forms an input to the next pass of the processing performed by the simulation logic 1202.

In the second pass, a logic component 1212 performs the second phase of the LBE technique (also corresponding to the flow operation 916). That is, this process simulates collision of fluid particles that arrive at the same element. A logic component 1214 simulates the evaporation of water in the flow layer 904 and the movement of pigments from the flow layer 904 to the fixture layer 906 (corresponding to the fixation operation 918). A logic component 1216 renders the output of the second pass to the canvas image information. The resultant colors produced in this process represent a combination of the pigments in the three layers (902, 904, 906).

In executing the above-described process, the simulation logic 1202 maintains various kinds of state information. For each element of the surface layer 902, the simulation logic 1202 stores water concentration information, glue concentration information, color information, and color concentration information (α). The simulation logic 1202 can represent the color information in CMY space. For each element in the flow layer 904, the simulation logic 1202 stores LBE particle distribution information for the nine vectors identified above, glue concentration information, color-related information (CMYα), and a blocking factor (κ) (to be described in Section D). For each element of the fixture layer 906, the simulation logic 1202 stores color-related information (CMYα) associated with the pigments that have come to rest in this layer 906.

A logic component 1218 defines a bounding box of elements for which the above-described two-pass processing is to be performed. The logic component 1218 can update this bounding box after each iteration of the processing, e.g., to take account for the movement of watercolor paint, the application of new paint strokes, and so on. The logic component 1218 can repeat its processing until all of the elements in the bounding box have dried. The logic component 1218 creates a new bounding box when (and if) the user later applies another paint stroke. The logic component 1218 also initiates the two-pass iterative processing with respect to the elements in the new bounding box.

Another logic component 1220 can make various adjustments to the two-pass process to make it more efficient. For example, the logic component 1220 can determine whether the machine functionality 802 has failed to meet a threshold level of performance when executing the two-pass processing. If so, the logic component 1220 can decrease the frequency at which the processing is performed and the canvas image information is updated. Alternatively, or in addition, the logic component 1220 can coarsen the granularity of elements for which analysis is performed, e.g., by increasing the size of the elements shown in FIG. 10.

The simulation logic 1202 can adopt other measures to make the two-pass processing more efficient. In one case, the simulation logic 1202 can store an instance of first information for each element in the flow layer 904. That instance of the first information expresses the particle density associated with that element. Each instance of the first information has a first size, such as 16 bits in one non-limiting example. The simulation logic 1202 can then store an instance of second information for each of the nine directions (eᵢ) shown in FIG. 10, for each element in the flow layer 904. Each instance of the second information represents a percentage of the particle density (expressed by the first information) that is moving in a particular direction. Because of its fractional and relative nature, the simulation logic 1202 can represent each instance of the second information using a second size which is less than the first size, such as 8 bits in one non-limiting example. Overall, this provision reduces the memory utilization of the two-pass processing.

According to another provision, the simulation logic 1202 can use stencil buffer functionality to define the portion of the simulation space for which the above-described two-pass processing is performed. For example, the simulation logic 1202 need not perform processing for sections of the simulation space in which all of the elements are dry. The simulation logic 1202 can use the stencil buffer functionality to mask out the regions for which updating is not required. In other cases, the simulation logic 1202 can demarcate different regions of the simulation space and perform the two-pass processing for these regions at different respective update rates.

Still other techniques can be employed for accelerating the processing performed by the simulation logic 1202.

B. Illustrative Processes

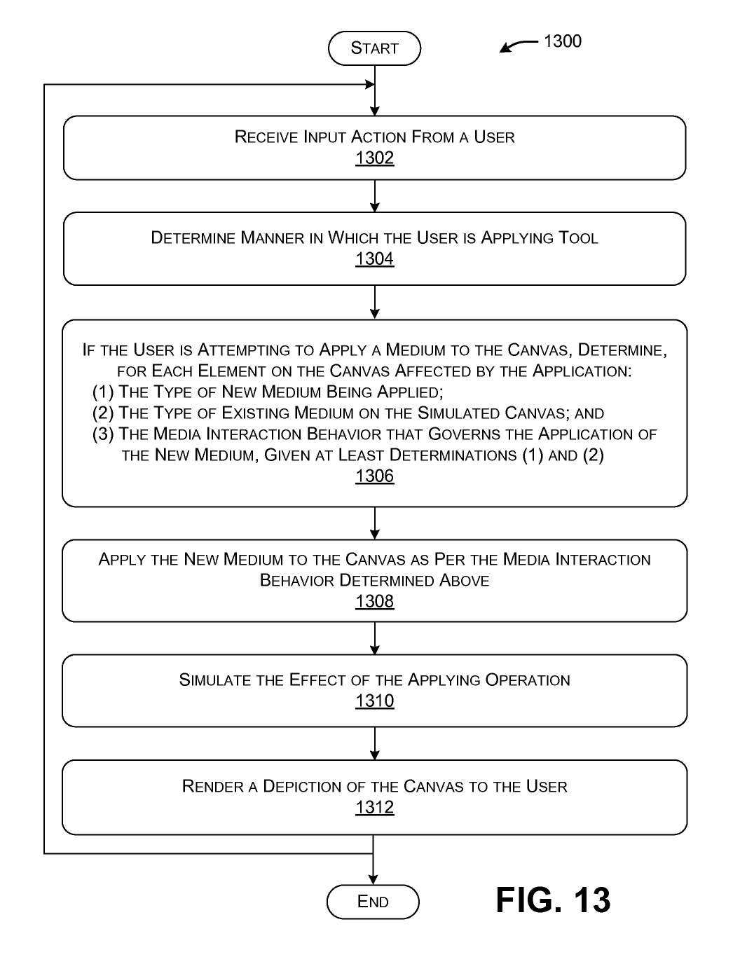

FIG. 13 shows a procedure 1300 that explains one manner of operation of the graphics system 100 of FIG. 1. Since the principles underlying the operation of the graphics system 100 have already been described in Section A, certain operations will be addressed in summary fashion in this section.

In block 1302, the graphics system 100 receives an input action from a user. In block 1304, the graphics system 100 determines a manner in which a user is applying a simulated tool. For example, the graphics system 100 determines whether the user has manipulated the tool to deposit a new medium on the surface layer of the simulated canvas. In block 1306, the graphics system 100 determines, for each position of the simulated canvas affected by the application of the new medium: (1) the type of new medium that the user is attempting to add to the simulated canvas; (2) the type of existing medium already applied to the simulated canvas (if any); and (3) the media interaction behavior that governs the manner in which the new medium is applied to the existing medium, if possible. Representative types of behaviors described in Section A include: (a) “apply over,” in which the graphics system 100 adds the new medium over the existing medium; (b) “non-apply,” in which the graphics system 100 prohibits the application of the new medium over the existing medium; and (c) “mixing,” in which the graphics system 100 mixes the new medium with the existing medium.

In block 1308, the graphics system 100 applies the new medium to the simulated canvas, if possible, in accordance with the media mixing behavior determined in block 1306. In block 1310, the graphics system 100 simulates the effects of adding the new medium to the existing medium, to produce canvas image information. In one case, block 1310 may correspond to the three-layer watercolor processing described above. In block 1312, the graphics system 100 renders a depiction of the simulated canvas to the user based on the canvas image information, or outputs the canvas image information to some other output device.

C. Representative Computing Functionality

FIG. 14 sets forth an illustrative type of computing functionality 1400 that can be used to implement any aspect of the graphics system 100 described above. In one case, the computing functionality 1400 may correspond to any type of computing device that includes one or more processing devices. In all cases, the computing functionality 1400 represents one or more physical and tangible processing mechanisms, either provided at a single site or distributed over plural sites.

The computing functionality 1400 can include volatile and non-volatile memory, such as RAM 1402 and ROM 1404, as well as one or more processing devices (e.g., one or more CPUs 1406, one or more GPUs 1408, etc.). The computing functionality 1400 also optionally includes various media devices 1410, such as a hard disk module, an optical disk module, and so forth. The computing functionality 1400 can perform various operations identified above when the processing devices (1406, 1408) execute instructions that are maintained by memory (e.g., RAM 1402, ROM 1404, or elsewhere).

More generally, instructions and other information can be stored on any computer readable medium 1412, including, but not limited to, static memory storage devices, magnetic storage devices, optical storage devices, and so on. The term computer readable medium also encompasses plural storage devices. In many cases, the computer readable medium 1412 represents some form of physical and tangible entity. The term computer readable medium also encompasses propagated signals, e.g., transmitted or received via physical conduit and/or air or other wireless medium, etc. However, the specific terms “computer readable storage medium” and “computer readable medium device” expressly exclude propagated signals per se, while including all other forms of computer readable media.

The computing functionality 1400 also includes an input/output module 1414 for receiving input information from various input mechanisms 1416, and for providing output information to various output mechanisms. One particular output mechanism may include a presentation device 1418 and an associated graphical user interface (GUI) 1420. The computing functionality 1400 can also include one or more network interfaces 1422 for exchanging data with other devices via one or more communication conduits 1424. One or more communication buses 1426 communicatively couple the above-described components together.

The communication conduit(s) 1424 can be implemented in any manner, e.g., by a local area network, a wide area network (e.g., the Internet), etc., or any combination thereof. The communication conduit(s) 1424 can include any combination of hardwired links, wireless links, routers, gateway functionality, name servers, etc., governed by any protocol or combination of protocols.

Alternatively, or in addition, any of the functions described in the preceding sections can be performed, at least in part, by one or more hardware logic components. For example, without limitation, the computing functionality can be implemented using one or more of: Field-programmable Gate Arrays (FPGAs); Application-specific Integrated Circuits (ASICs); Application-specific Standard Products (ASSPs); System-on-a-chip systems (SOCs); Complex Programmable Logic Devices (CPLDs), etc.

D. Appendix: Illustrative Modeling of Watercolor Movement

The graphics system 100 can simulate the movement of watercolor paint using different mathematical models. Without limitation, for instance, the graphics system 100 can apply the mathematical modeling described in the above-referenced Chu, et al. paper, “MoXi: Real-time Ink Dispersion in Absorbent Paper.” This Section describes illustrative modeling equations set forth in that paper, with cross reference back to the concepts set forth with respect to FIG. 9.

In one implementation, the graphics system 100 can model the flow of water φ from the surface layer 902 to the flow layer 904 by repetitively applying the equation: φ=clamp(s, 0, π−ρ). In this equation, s represents the quantity of water on the surface layer 902, ρ is the fluid density in the flow layer 904 (defined below), and π corresponds to the capacity of the simulated fibers in the canvas. The clamping function returns the clamped value of s, with respect to a minimum value of 0 and a maximum value of π−ρ. The movement of water to the flow layer 904 changes the values of s and ρ for a next calculation of flow φ.

The graphics system 100 can then use the LBE technique to simulate the flow of water in the flow layer 904. The following equation expresses both the streaming and collision phases of the LBE technique:

fᵢ(x+eᵢΔt,t+Δt)=(1−ω)fᵢ(x,t)+wfᵢ^{eq}(x,t).

In this equation, ω corresponds to a relaxation parameter (which is related to the viscosity of the fluid), Δt refers to the time interval between successive computations using the equation, and fᵢ^{eq}(x,t) refers to an equilibrium distribution function. In one implementation, the equilibrium distribution function may be expressed by:

$${f}_{i}^{eq} = {w}_{i} \{ ρ + {ρ}_{0} ψ [ \frac{3}{{c}^{2}} {e}_{i} \cdot u + \frac{9}{2 {c}^{4}} {( {e}_{i} \cdot u )}^{2} - \frac{3}{2 {c}^{2}} u \cdot u ] \} .$$

In this equation, ρ corresponds to the fluid density and u corresponds to velocity, which are respectively defined as:

$$ρ = {\sum }_{i = 0}^{8} {f}_{i} , \\ and \text{:}$$

$$u = \frac{1}{{ρ}_{0}} {\sum }_{i = 0}^{8} {e}_{i} {f}_{i} .$$

Further, the symbol ρ₀ corresponds to average fluid density, c corresponds to Δx/Δt (where Δx identifies a distance between two closest-neighboring elements in the lattice), wᵢ are constants that reflect the geometry of the lattice, ψ is a weight defined by ψ=smoothstep(0,δ,ρ) (where δ is a user-selected parameter, and the smoothstep operation implements cubic Hermite interpolation).

In one implementation, the streaming step can be more specifically expressed by:

fᵢ(x,t+1)=τᵢ(x)fₖ(x,t)+(1−τᵢ(x))fᵢ(x−eᵢ,t).

In this expression, fₖ refers to a particle distribution function associated with a direction that is opposite to the direction of fᵢ. The symbol τᵢ refers to a factor that operates in the above equation to block the flow of particles in a particular direction i. That is, each element in the lattice is associated with a blocking factor κ. The symbol τᵢ refers to the average of two blocking factors associated with two respective neighboring elements, with respect to the direction i. The blocking factor κ of each element itself represents the accumulated effect of plural factors which impede the flow of fluid. Those factors may include, but are not limited to, the grain of the paper, the variable amount of alum added to the paper, the variable concentration of glue in the flow layer 904, and so forth. Dispersion of fluid in the fibers is also affected by a pinning factor which creates temporary blockages.

Additional equations express the movement of pigments in the water. For example, assume that the symbol pₛ expresses the concentration of pigments in the surface layer 902, p_{f} expresses the concentration of pigments in the flow layer 904, and pₓ expresses the concentration of pigments in the fixture layer 906. The graphics system 100 can simulate the movement of pigments from the surface layer 902 to the flow layer 904 according to the equation: p_{f}←(p_{f}ρ+pₛφ)/(ρ+φ). The graphics system 100 can simulate the movement of pigments within the flow layer 904 itself as an advection process. And the graphics system 100 can simulate the movement of pigments from the flow layer 904 to the fixture layer 906 to achieve behavior in which: (1) the flow of pigments decreases as the paint dries out; and (2) the flow of pigments decreases with an increase in glue concentration. As noted above, the graphics system 100 treats the pigments as stable in the fixation layer 906 when the paint completely dries out.

In closing, the description may have described various concepts in the context of illustrative challenges or problems. This manner of explanation does not constitute an admission that others have appreciated and/or articulated the challenges or problems in the manner specified herein. Further, the claimed subject matter is not limited to implementations that solve any or all of the noted challenges/problems.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method, performed by physical computing functionality, for simulating interaction of differing media, comprising:
receiving an input action;
in response to the input action, determining, for each affected position on a simulated canvas:
a type of new medium being applied to the simulated canvas at the position;
a type of existing medium already applied to the simulated canvas at the position; and
a media interaction behavior to be applied at the position, the media interaction behavior being based on at least the type of new medium and the type of existing medium that has been determined;
applying the new medium to the simulated canvas in accordance with the media interaction behavior that has been determined, providing that the media interaction behavior permits said applying;
simulating an effect produced by said applying, to produce canvas image information; and
rendering a depiction of the simulated canvas on an output mechanism based on the canvas image information.

2. The method of claim 1, wherein one media interaction behavior specifies that the new medium is to be applied over the existing medium.

3. The method of claim 1, wherein one media interaction behavior specifies that the new medium is not to be applied over the existing medium.

4. The method of claim 1, wherein one media interaction behavior specifies that the new medium is to be mixed with the existing medium.

5. The method of claim 1, further comprising determining whether the existing medium at each position is wet or dry, and wherein said determining of the media interaction behavior is further based on whether the existing medium is wet or dry.

6. The method of claim 1, wherein said determining comprises consulting an adhesion matrix table that specifies media interaction behaviors for different respective combinations of media types, the adhesion matrix table being extensible in that it accommodates adding new media types and new media interaction behaviors, and changes in existing media types and media interaction behaviors.

7. The method of claim 1, wherein:
the new medium is a watercolor medium;
the existing medium is a hydrophobic medium that is at least partially water repellent in nature; and
the media interaction behavior specifies that the new media is not to be applied over the existing medium.

8. The method of claim 7, wherein the hydrophobic medium is an oil medium, a graphite medium, or a pastel medium.

9. The method of claim 1, wherein the simulated canvas is modeling as having three layers, including a surface layer, a flow layer, and a fixture layer.

10. The method of claim 9, wherein:
the new medium is a watercolor medium,
the watercolor medium is applied adjacent to the existing medium,
the media interaction behavior specifies that the new medium is not to be applied over the existing medium, and
said simulating comprises simulating tunneling of the watercolor medium beneath the existing medium in the flow layer.

11. The method of claim 9, wherein:
the new medium is a watercolor medium,
said simulating comprises simulating movement of particles in plural discrete directions in the flow layer at each affected position in the flow layer, and
the method further comprising:
storing first information, for each affected position, that identifies a particle density provided at that position; and
storing second information, for each affected position and for each discrete direction, that identifies a particle density that is being propagated in that direction,
wherein each instance of the second information is expressed as a fraction of the first information, such that a size of each instance of the second information is less than the first information.

12. The method of claim 9, further comprising:
receiving and executing a command to erase media previously added to a portion of the simulated canvas; and
continuing simulation of an effect of adding a watercolor medium to the simulated canvas following execution of the erase command, providing that at least a portion of the flow layer is still wet when the erase command is executed.

13. The method of claim 9, further comprising:
storing state information which expresses state information associated with the surface layer, flow layer, and fixture layer; and
receiving and executing a command to undo a previous media application operation by consulting the state information.

14. The method of claim 1, wherein the canvas image information expresses, for each element, a combination of color information and pigment concentration, the color information being expressed in an additive color space.

15. A graphics system, implemented by physical computer functionality, for simulating application of a watercolor medium on a simulated canvas, the simulated canvas being modeled as having a surface layer, a flow layer, and a fixture layer, the graphics system comprising:
logic configured to assess a footprint of a tool on the surface layer of the simulated canvas as the tool applies a watercolor medium to the simulated canvas;
logic configured to assess, for each affected position on the simulated canvas defined by the foot print:
a type of existing medium already applied to the simulated canvas at the position; and
a media interaction behavior to be applied at the position, the media interaction behavior being based on at least the type of existing medium that has been determined;
logic configured to apply the watercolor medium to the simulated canvas in accordance with the media interaction behavior that has been determined, providing that media interaction behavior permits application of the watercolor medium;
logic configured to simulate an effect produced by application of the watercolor medium, to produce canvas image information; and
logic configured to render a depiction of the simulated canvas based on the canvas image information.

16. The graphics system of claim 15, wherein the media interaction behavior specifies:
that the watercolor medium is to be applied over the existing medium;
that the watercolor medium is not to be applied over the existing medium; or
that the watercolor medium is to be mixed with the existing medium.

17. The graphics system of claim 15, wherein:
the media interaction behavior specifies that the new medium is not to be applied over the existing medium, and
said logic configured to simulate comprises logic configured to simulate tunneling of the watercolor medium beneath the existing medium in the flow layer.

18. The graphics system of claim 15, wherein the computer functionality includes one or more central processing units (CPUs) and one or more graphical processing units (GPUs), and wherein at least a portion of said logic configured to simulate is implemented by said one or more GPUs.

19. A computer readable storage medium for storing computer readable instructions, the computer readable instructions providing a graphics system when executed by one or more processing devices, the computer readable instructions comprising:
logic configured to apply a watercolor medium adjacent to a hydrophobic medium on a simulated canvas, the simulated canvas being modeling as having a surface layer, a flow layer, and a fixture layer;
logic configured to simulate tunneling of the watercolor medium in the flow layer, beneath the hydrophobic medium; and
logic configured to simulate fixture of pigment from the watercolor medium in the fixture layer.

20. The computer readable storage medium of claim 19, wherein the watercolor medium that tunnels beneath the hydrophobic medium also extends beyond a perimeter associated with the hydrophobic medium, and wherein the watercolor medium that extends beyond the perimeter also contributes to the pigment in the fixture layer.
